(19) United States
(12) Patent Application Publication
(10) Pub. No.: US 2020/0201087 A1
(43) Pub. Date: Jun. 25, 2020

(54) OPTICAL CONTROL ELEMENT AND DISPLAY DEVICE

(71) Applicant: Au Optronics Corporation, Hsinchu (TW)

(72) Inventors: Hsin-Hung Li, Hsinchu (TW); Chun-Hsiang Chan, Hsinchu (TW); To-Cheng Fan, Hsinchu (TW); Ting-Wei Tsai, Hsinchu (TW); Chi-Sheng Chiang, Hsinchu (TW); Min-Ching Tsai, Hsinchu (TW)

(73) Assignee: Au Optronics Corporation, Hsinchu (TW)

(21) Appl. No.: 16/520,330

(22) Filed: Jul. 23, 2019

(30) Foreign Application Priority Data
Dec. 20, 2018 (TW) 107146276

(51) Int. Cl. G02F 1/13; G02F 1/1335; G02F 1/1347

(52) U.S. Cl. CPC G02F 1/1323; G02F 1/133553; G02F 2001/13478; G02F 1/133605; G02F 1/1347

(57) ABSTRACT

An optical control element for a light beam to pass through and including a transparent substrate and a plurality of reflective structures is provided. The transparent substrate has a light-entering surface and a light-emitting surface opposite to each other. The reflective structures are disposed in the transparent substrate. Each of the reflective structures has a bottom surface adjacent to the light-entering surface and a side surface connected to the bottom surface. A width of each reflective structure in a direction of a horizontal view angle is gradually decreased from one end adjacent to the light-entering surface to one end away from the light-entering surface. The bottom surface and the side surface respectively reflect parts of the light beam, and in a direction vertical to the bottom surface, transmission directions of the light beam reflected by the bottom surface and that reflected by the side surface are opposite to each other.

### CROSS-REFERENCE TO RELATED APPLICATION

This application claims the priority benefit of Taiwan application serial no. 107146276, filed on Dec. 20, 2018. The entirety of the above-mentioned patent application is hereby incorporated by reference herein and made a part of this specification.

### BACKGROUND

### Field of the Invention

The invention is directed to an optical element and an electronic device and more particularly, to an optical control element and a display device.

### Description of Related Art

In a current liquid crystal display (LCD) using a back-light module, the back-light module is turned on round-the-clock and provides back light once the LCD is activated. Thus, when an image is displayed, a display medium containing a liquid crystal material in the LCD is used to turn on or turn off the back light provided by the back-light module to allow or not allow the back light to pass through. However, when the LCD is in a dark state (i.e., the display medium containing the liquid crystal material is used to turn off the back light provided by the back-light module to block the back light from passing through), the display medium containing the liquid crystal material is incapable of completely shielding the light located at a wide view angle of a display surface. Thus, a phenomenon of dark-state light leakage of the display panel caused by a wide view angle of the LCD occurs, which results in a poor contrast for displaying the image.

In current applications, a light-shielding element having a black light-absorbing material may be used for adjusting the back light, such that the back light, when passing through the light-shielding element, absorbs the light at a wide angle while allowing only the light at a small angle to pass through, thereby resolving the issue of light leakage caused by the wide view angle of the LCD. Nevertheless, the light-shielding element disposed with the black light-absorbing material may also cause brightness in a front-view direction to be dramatically reduced, which further results in poor overall light efficiency.

### SUMMARY

The invention provides an optical control element and a display device capable of preventing a phenomenon of light leakage at a wide view angle when the display device is in a dark state.

According to an embodiment of the invention, an optical control element adapted to allow a light beam to pass through and including a transparent substrate and a plurality of reflective structures is provided. The transparent substrate has a light-entering surface and a light-emitting surface opposite to each other. The reflective structures are disposed in the transparent substrate, and each of the reflective structures has a bottom surface adjacent to the light-entering surface and a side surface connected to the bottom surface, wherein a width of each reflective structure in a direction of a horizontal view angle is gradually decreased from one end adjacent to the light-entering surface to one end away from the light-entering surface. The bottom surface and the side surface are respectively adapted to reflect parts of the light beam, and in a direction vertical to the bottom surface, transmission directions of the part of the light beam reflected by the bottom surface and the part of the light beam reflected by the side surface are opposite to each other.

According to another embodiment of the invention, a display device adapted to provide a display beam is provided. The display device includes a light source module, an optical control element and a display module. The light source module is adapted to provide an illumination beam. The optical control element is disposed on a transmission path of the illumination beam and adapted to adjust the illumination beam as an optimized beam. The optical control element includes a transparent substrate and a plurality of reflective structures. The transparent substrate has a light-entering surface and a light-emitting surface opposite to each other. The reflective structures are disposed in the transparent substrate, and each of the reflective structures has a bottom surface adjacent to the light-entering surface and a side surface connected to the bottom surface, wherein a width of each reflective structure in a direction of a horizontal view angle is gradually decreased from the end adjacent to the light-entering surface to the end away from the light-entering surface. The bottom surface is adapted to reflect a part of the illumination beam to the light source module, and the side surface is adapted to reflect a part of the illumination beam to the display module.

To sum up, in the optical control element and the display device of the invention, the optical control element is disposed between the light source module and the display module, and the optical control element includes a plurality of reflective structures, such that the light beam passing therethrough can be reflected to the light source module by the bottom surfaces of the reflective structures and reflected to the display module by the side surfaces of the reflective structures to reduce a light-emitting angle in the horizontal direction. Thus, with a reflection effect of the reflective structures, the use efficiency of the light beam can be enhanced, and the horizontal view angle that the light beam passes through the optical control element can be reduced, such that the phenomenon of light leakage at the wide view angle when the display device is in the dark state can be prevented.

To make the above features and advantages of the invention more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view illustrating a display device according to an embodiment of the invention.

FIG. 2 is a partially enlarged schematic diagram illustrating the optical control element depicted in FIG. 1.

FIG. 3 is a schematic bottom-view diagram illustrating the optical control element depicted in FIG. 1.

FIG. 4 is a schematic bottom-view diagram illustrating an optical control element according to another embodiment of the invention.

FIG. 5 is a schematic three-dimensional view diagram illustrating the reflective structure of FIG. 4.

FIG. 6 is a schematic bottom-view diagram illustrating an optical control element according to another embodiment of the invention.

### DESCRIPTION OF EMBODIMENTS

In the drawings related to the description set forth below, for illustrative clearness, the thicknesses of, for instance, layers, films, panels, and regions are enlarged. Throughout the specification, the same reference numerals represent the same elements. It should be understood that, when an element such as a layer, film, region, or substrate is referred to as being “on” another element or “connected to” another element, the element may be directly on the other element or connected to the other element, or an intermediate element may be provided between the two. On the contrary, when an element is referred to as “directly on another element” or “directly connected to” another element, an intermediate element is omitted. As used in the present specification, “connected” may refer to being physically and/or electrically connected (coupled). Therefore, the “electrical connection” or “coupling” between two elements may include another element.

It should be noted that although the terms “first”, “second”, “third”, etc. may be used for describing various elements, components, regions, layers and/or portions, the elements, components, regions, layers and/or portions are not limited by these terms. These terms are only used for separating one element, component, region, layer or portion from another element, component, region, layer or portion. Therefore, the following discussed “first element”, “component”, “region”, “layer” or “portion” may be referred to as the second element, component, region, layer or portion without departing from the scope of the invention.

The terminology used herein is for the purpose of describing particular embodiments and is not intended to be limiting of the invention. As used herein, the singular forms “a,” “an” and “the” are intended to include the plural forms as well, unless the context clearly indicates otherwise. “or” represents “and/or”. The term “and/or” used herein includes any or a combination of one or more of the associated listed items. It will be further understood that the terms “comprises,” “comprising,” “includes” and/or “including,” when used herein, specify the presence of stated features, regions, integers, steps, operations, elements, and/or components, but do not preclude the presence or addition of one or more other features, regions, integers, steps, operations, elements, components, and/or groups thereof.

Moreover, relative terms such as “under” or “bottom” and “above” or “top” may be used for describing a relationship of one element and another element as that shown in figures. It should be noted that the relative terms are intended to include a different orientation of the device besides the orientation shown in the figure. For example, if a device in a figure is flipped over, the element originally described to be located “under” other element is oriented to be located “above” the other element. Therefore, the illustrative term “under” may include orientations of “under” and “on”, which is determined by the specific orientation of the figure. Similarly, if a device in a figure is flipped over, the element originally described to be located “below” or “underneath” other element is oriented to be located “on” the other element. Therefore, the illustrative term “under” or “below” may include orientations of “above” and “under”.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

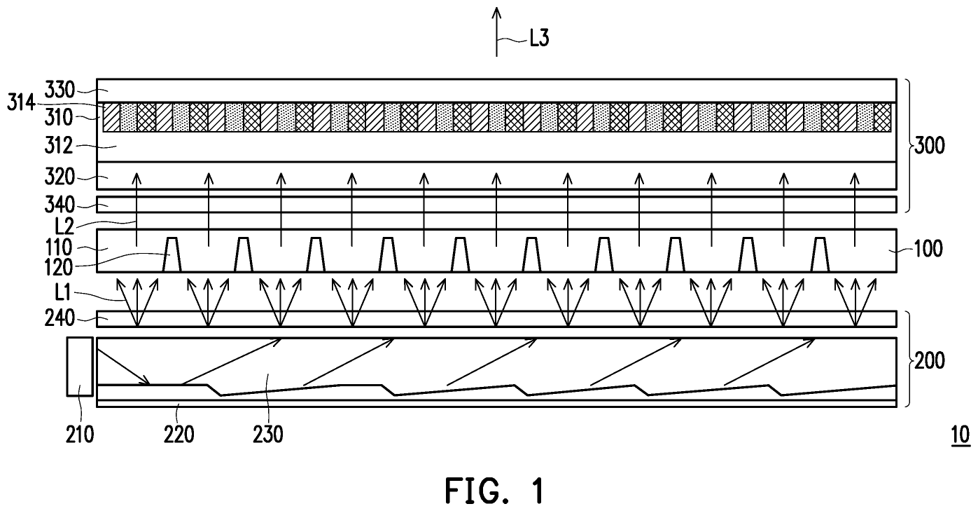

FIG. 1 is a schematic cross-sectional view illustrating a display device according to an embodiment of the invention. Referring to FIG. 1, an embodiment of the invention provides a display device 10 capable of preventing a phenomenon of light leakage when the display device 10 is in a dark state. The display device 10 includes a light source module 200, an optical control element 100 and a display module 300. In the present embodiment, the display device 10 is, for example, a liquid crystal display (LCD), but the invention is not limited thereto. It is supplementally mentioned that the display device 10 in the dark state refers to an image screen presented to and observed by a user when the display module 300 is in an off state to block a light beam provided by the light source module 200 after the display device 10 is activated, and the display device 10 in a bright state refers to an image screen presented to and observed by the user when the display module 300 is in an on state to allow the light beam provided by the light source module 200 to pass through after the display device 10 is activated.

Specifically, in the present embodiment, the light source module 200 includes a light emitting module 210, a reflective element 220, a light guide element 230 and a first optical module 240. The light source module 200 is, for example, a side type back-light module, and the light emitting module 210, is, for example, a light-emitted diode (LED). However, in other embodiments, the light source module 200 may also be, for example, a direct type back-light module, but the invention is not limited thereto. The reflective element 220 is disposed below the light guide element 230 to reflect the light provided by the light emitting module 210, and an illumination beam L1 is guided through a light guide effect by the light guide element 230 and is transmitted to the optical control element 100. The first optical module 240 is, for example, a diffusion sheet, a brightness enhancement film (BEF) or other optical elements or a combination thereof, but the invention is not limited thereto.

When the display device 10 is used, the light source module 200 provides the illumination beam L1 to the optical control element 100, and the optical control element 100 adjusts the illumination beam L1 as an optimized beam L2. Lastly, the display module 300 receives the optimized beam L2 to provide a display beam L3 carrying with screen information. Specifically, in the present embodiment, the display module 300 is disposed on a transmission path of the optimized beam L2, and the display module 300 includes a display medium layer 310, a lower polarization layer 320, an upper polarization layer 330 and a second optical module 340. The display module 300 is, for example, a liquid crystal display (LCD) panel. The display medium layer 310 includes, for example, a combination of a display medium 312 containing liquid crystal molecules and a color filter 314. Thus, when the display device 10 is used, the optimized beam L2 provided by the optical control element 100 may sequentially pass though the lower polarization layer 320, the display medium layer 310 and the upper polarization layer 330 to generate the display beam L3 carrying with the screen information. The second optical module 340 is, for example, a BEF, a reflective BEF or other optical elements, but the invention is not limited thereto.

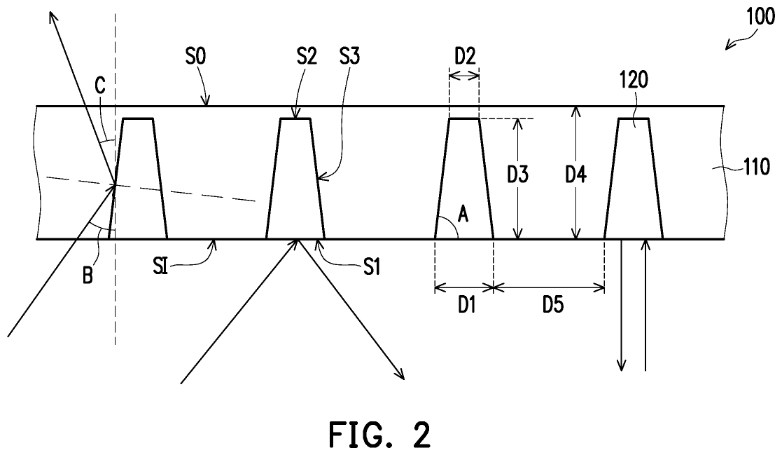

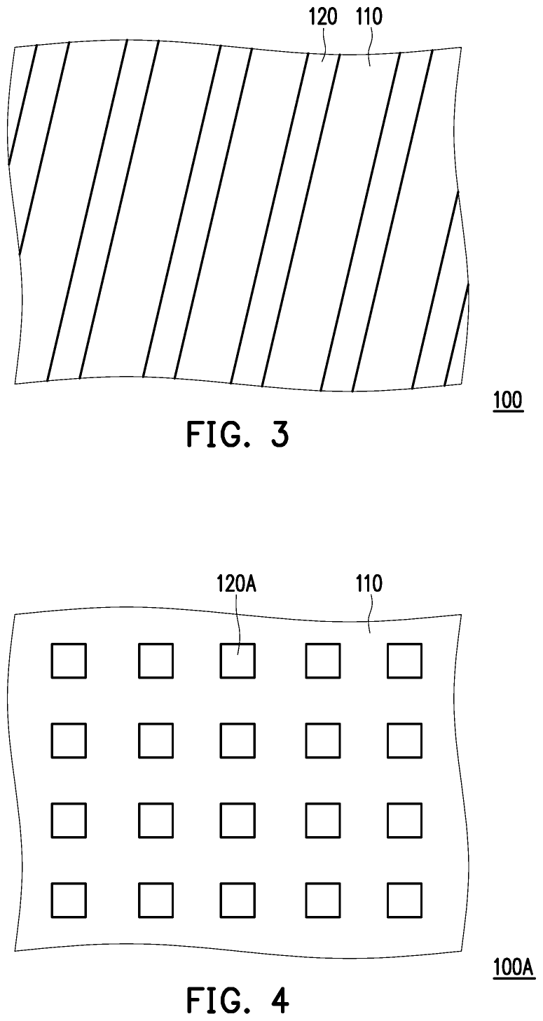

FIG. 2 is a partially enlarged schematic diagram illustrating the optical control element depicted in FIG. 1. FIG. 3 is a schematic bottom-view diagram illustrating the optical control element depicted in FIG. 1. Referring to both FIG. 1 and FIG. 3, the optical control element 100 is disposed on a transmission path of the illumination beam L1. Specifically, the optical control element 100 includes a transparent substrate 110 and a plurality of reflective structures 120. The transparent substrate 110 has a light-entering surface SI and a light-emitting surface SO opposite to each other. The transparent substrate 110 is made of a transparent material, such as poly methyl methacrylate (PMMA), polystyrene (PS) or glass, but the invention is not limited thereto.

The reflective structures 120 are strip columns disposed in the transparent substrate 110, and each adjacent reflective structures 120 are separated from each other by a distance. In the present embodiment, the reflective structures 120 are, for example, optical reflective structures made of a metal, such as titanium dioxide (TiO2) or aluminum, silver, nickel or chromium and adapted to reflect an incident light beam by surfaces thereof, but the invention is not limited thereto. Specifically, in the present embodiment, each of the reflective structures 120 has a bottom surface S1 adjacent to the light-entering surface SI, a top surface S2 adjacent to the light-emitting surface SO and a side surface S3 connected between the bottom surface S1 and the top surface S2, wherein the bottom surface Si of each of the reflective structures 120 is adapted to reflect a part of the illumination beam L1 to the light source module 200, and the side surface S3 of each of the reflective structures 120 is adapted to reflect a part of the illumination beam L1 to the display module 300.

A rang of a width D1 of the bottom surface S1 in a horizontal view angle is between 10 μm and 1000 μm, and a rang of a width D2 of the top surface S2 in the horizontal view angle is between 0 μm and 1000 μm. In addition, a vertical distance D3 from the bottom surface S1 to the top surface S2 of each of the reflective structures 120 (which is a height of each of the reflective structures 120) ranges from 10 μm to 1000 μm, a vertical distance D4 from the light-entering surface SI to the light-emitting surface SO of the transparent substrate 110 (which is a thickness of each of the transparent substrate 110) ranges from 10 μm to 2000 μm, and a ratio of the vertical distance D3 from the bottom surface S1 to the top surface S2 of each of the reflective structures 120 to the width D1 of the bottom surface S1 in the horizontal view angle ranges from 1 to 10. In other words, in the present embodiment, the bottom surface S1 of each of the reflective structures 120 is coplanar with the light-entering surface SI of the transparent substrate 110. However, in different embodiments, the top surface S2 of each of the reflective structures 120 may be selectively coplanar with the light-emitting surface SO of the transparent substrate 110 or separated from the light-emitting surface SO of the transparent substrate 110 by a distance, but the invention is not limited thereto.

In the present embodiment, a width of each of the reflective structures in a direction of the horizontal view angle (and in an extension direction parallel to the transparent substrate 110) is gradually decreased from one end adjacent to the light-entering surface SI to one end away from the light-entering surface SI, as illustrated in FIG. 2. In other words, an included angle A between the side surface S3 between the bottom surface S1 and the top surface S2 and the bottom surface S1 is smaller than 90 degrees. In the present embodiment, the included angle A between the side surface S3 and the bottom surface S1 of each of the reflective structures 120 ranges between 60 degrees and 90 degrees. In a preferred embodiment, the included angle A ranges between 70 degrees and 80 degrees. In a more preferred embodiment, the included angle A is approximately 75 degrees. Besides, in the present embodiment, a shape of the bottom surface S1 of each of the reflective structures 120 on a plane parallel to the light-entering surface SI of the transparent substrate 110 is a parallelogram, and thus, a plurality of trapezoidal strip columns with an interval from each another are formed, as illustrated in FIG. 3. In the present embodiment, a distance D5 between the bottom surfaces S1 of each two adjacent reflective structures 120 ranges from 50 μm to 2000 μm.

When the illumination beam L1 is transmitted from the light source module 200 toward the optical control element 100, the part of the illumination beam L1 transmitted to the bottom surface S1 of each of the reflective structures 120 is reflected back to the light source module 200. Thus, the part of the illumination beam L1 reflected by the bottom surface S1 of each of the reflective structures 120 is transmitted to the light guide element 230 of the light source module 200 for being used again. In addition, the part of the illumination beam L1 transmitted to the side surface S3 of each of the reflective structures 120 is reflected to the display module 300. Thus, an included angle B included by the incident light on the side surface S3 and a front-view direction is reduced to be an included angle C included by the reflected light and the front-view direction. In this way, with a reflection effect of the reflective structures 120, the use efficiency of the light beam may be further enhanced, and the horizontal view angle that the light beam passes through the optical control element 100 may be further reduced, such that the phenomenon of light leakage at a wide view angle when the display device is in the dark state may be prevented. In some embodiments, each of the reflective structures 120 may have only the bottom surface S1 and the side surface S3 to form a tapered three-dimensional (3D) structure, and thus, a plurality of tapered strip columns with an interval from each another are formed, but the invention is not limited thereto.

It should be noted that in the present embodiment, the extension direction of each of the reflective structures 120 is inclined with respect to a boundary of the transparent substrate 110 by an angle, as illustrated in FIG. 3. In this way, after the optical control element 100 transmits the optimized beam L2 to the display module 300, the display beam L3 carrying with the screen information provided by the display module 300 may be prevented from generating an interference fringe, for example, a moire fringe.

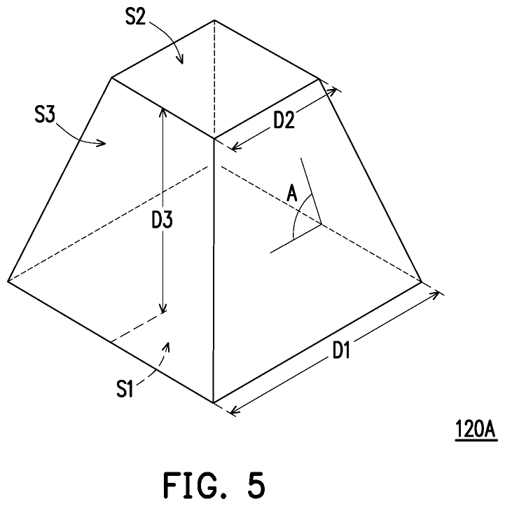

FIG. 4 is a schematic bottom-view diagram illustrating an optical control element according to another embodiment of the invention. FIG. 5 is a schematic three-dimensional view diagram illustrating the reflective structure of FIG. 4. Referring to FIG. 4 and FIG. 5, an optical control element 100A of the present embodiment is similar to the optical control element 100 illustrated in FIG. 3, and the difference therebetween is as follows. Reflective structures 120A may be a plurality of quadrangular columns or a plurality of quadrangular pyramids. In the present embodiment, reflective structures 120A is a plurality of quadrangular pyramids. In the present embodiment, each of the reflective structures 120A is arranged in an array in the transparent substrate 110. In this way, with a reflection effect of the reflective structures 120A, the use efficiency of the light beam may be further enhanced, and the horizontal view angle and the vertical view angle that the light beam passes through the optical control element 100A may be further reduced, such that the phenomenon of light leakage at the wide view angle when the display device 10 is in the dark state may be prevented.

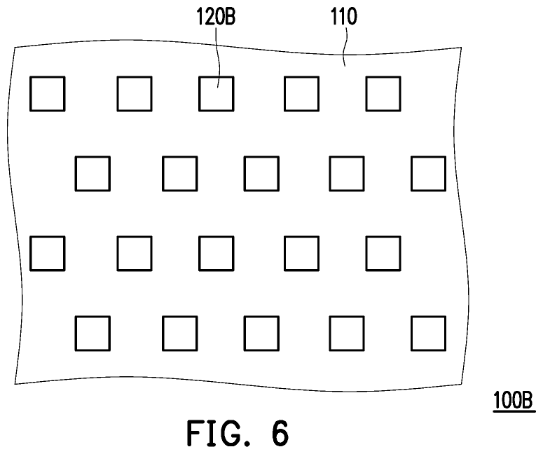

FIG. 6 is a schematic bottom-view diagram illustrating an optical control element according to another embodiment of the invention. Referring to FIG. 6, an optical control element 100B of the present embodiment is similar to the optical control element 100A illustrated in FIG. 4, and the difference therebetween is as follows. In the present embodiment, reflective structures 120B are arranged in an array in a dislocation manner in the transparent substrate 110. In this way, with a reflection effect of the reflective structures 120B, the use efficiency of the light beam may be further enhanced, and the horizontal view angle and the vertical view angle that the light beam passes through the optical control element 100B may be further reduced, such that the phenomenon of light leakage at the wide view angle when the display device 10 is in the dark state may be prevented. In some embodiments, the reflective structures 120B may also be arranged in other arrangement manners or irregular manners, but the invention is not limited thereto.

In light of the foregoing, in the optical control element and the display device of the invention, the optical control element is disposed between the light source module and the display module, and the optical control element includes a plurality of reflective structures, such that the light beam passing therethrough can be reflected to the light source module by the bottom surfaces of the reflective structures and reflected to the display module by the side surfaces of the reflective structures to reduce the light-emitting angle in the horizontal direction. Thus, with the reflection effect of the reflective structures, the use efficiency of the light beam can be enhanced, and a horizontal view angle that the light beam passes through the optical control element can be reduced, such that the phenomenon of light leakage at the wide view angle when the display device is in the dark state can be prevented.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An optical control element, adapted to allow a light beam to pass through, comprising:
a transparent substrate, having a light-entering surface and a light-emitting surface opposite to each other;
a plurality of reflective structures, disposed in the transparent substrate, and each of the reflective structures having a bottom surface adjacent to the light-entering surface and a side surface connected to the bottom surface, wherein a width of each of the reflective structures in a direction of a horizontal view angle is gradually decreased from one end adjacent to the light-entering surface to one end far away from the light-entering surface, the bottom surface and the side surface are respectively adapted to reflect parts of the light beam, and in a direction vertical to the bottom surface, and a transmission direction of the part of the light beam reflected by the bottom surface and a transmission direction of the part of the light beam reflected by the side surface are opposite to each other.

2. The optical control element according to claim 1, wherein each of the reflective structures further has a top surface, and the side surface is connected between the bottom surface and the top surface.

3. The optical control element according to claim 1, wherein a shape of the bottom surface of each of the reflective structures on a plane parallel to the light-entering surface of the transparent substrate is a parallelogram.

4. The optical control element according to claim 1, wherein an included angle between the side surface and the bottom surface of each of the reflective structures ranges between 60 degrees and 90 degrees, and a ratio of a vertical distance from the bottom surface to the top surface of the reflective structure to a width of the bottom surface in the horizontal view angle ranges from 1 to 10.

5. The optical control element according to claim 1, wherein the extension direction of each of the reflective structures is inclined with respect to a boundary of the transparent substrate by an angle, and a distance between the bottom surfaces of each two adjacent reflective structures ranges from 50 μm to 2000 μm.

6. The optical control element according to claim 1, wherein each of the reflective structures is arranged in an array.

7. The optical control element according to claim 1, wherein a vertical distance from the bottom surface to the top surface of each of the reflective structures ranges from 10 μm to 1000 μm, a vertical distance from the light-entering surface to the light-emitting surface of the transparent substrate ranges from 10 μm to 2000 μm.

8. A display device, adapted to provide a display light beam, comprising:
a light source module, adapted to provide an illumination beam;
an optical control element, disposed on a transmission path of the illumination beam, adapted to adjust the illumination beam as an optimized beam, and comprising:
a transparent substrate, having a light-entering surface and a light-emitting surface opposite to each other;
a plurality of reflective structures, disposed in the transparent substrate, and each of the reflective structures having a bottom surface adjacent to the light-entering surface and a side surface connected to the bottom surface; and
a display module, disposed on a transmission path of the optimized beam, wherein a width of each of the reflective structures in a direction of a horizontal view angle is gradually decreased from one end adjacent to the light-entering surface to one end far away from the light-entering surface, the bottom surface is adapted to reflect a part of the illumination beam to the light source module, and the side surface is adapted to reflect a part of the illumination beam to the display module.

9. The display device according to claim 8, wherein each of the reflective structures further has a top surface, and the side surface is connected between the bottom surface and the top surface.

10. The display device according to claim 8, wherein a shape of the bottom surface of each of the reflective structures on a plane parallel to the light-entering surface of the transparent substrate is a parallelogram.

11. The display device according to claim 8, wherein an included angle between the side surface and the bottom surface of each of the reflective structures ranges between 60 degrees and 90 degrees, and a ratio of a vertical distance from the bottom surface to the top surface of the reflective structure to a width of the bottom surface in the horizontal view angle ranges from 1 to 10.

12. The display device according to claim 8, wherein the extension direction of each of the reflective structures is inclined with respect to a boundary of the transparent substrate by an angle, and a distance between the bottom surfaces of each two adjacent reflective structures ranges from 50 μm to 2000 μm.

13. The display device according to claim 8, wherein each of the reflective structures is arranged in an array.

14. The display device according to claim 8, wherein a vertical distance from the bottom surface to the top surface of each of the reflective structures ranges from 10 μm to 1000 μm, a vertical distance from the light-entering surface to the light-emitting surface of the transparent substrate ranges from 10 μm to 2000 μm.
